(19) United States
(12) Patent Application Publication
(10) Pub. No.: US 2011/0134158 A1
(43) Pub. Date: Jun. 9, 2011

(54) BACKLIGHT APPARATUS AND IMAGE DISPLAY APPARATUS USING THIS BACK LIGHT APPARATUS

(75) Inventor: Toshiki ONISHI, Osaka (JP)

(73) Assignee: PANASONIC CORPORATION, Osaka (JP)

(21) Appl. No.: 12/959,042

(22) Filed: Dec. 2, 2010

(30) Foreign Application Priority Data
Dec. 7, 2009 (JP) 2009-277534

(51) Int. Cl. G09G 3/36; G09G 5/10

(52) U.S. Cl. 345/690; 345/102

(57) ABSTRACT

A backlight apparatus that can reduce transmission load and allows high quality local contrast control and an image display apparatus using this backlight apparatus are provided. An LED backlight (121) has a light emitting surface in which P light emitting areas that can each individually emit light are divided into Q groups, and radiates light from the P light emitting areas to a display panel (110). A feature amount detecting section (133) detects a feature amount of an image signal. A brightness calculating section (132) determines the light emission values of the P light emitting areas on a per light emitting area basis based on the feature amounts detected.

A backlight driving section (122) detects the light emitting states in the P light emitting areas on a per group basis based on the light emitting brightness values determined. The backlight driving section (122) changes the group in which the light emitting state is renewed, among the Q groups at a frequency of M times per one frame period of the image signal.

### CROSS REFERENCE TO RELATED APPLICATIONS

This application is entitled to (or claims) the benefit of Japanese Patent Application No. 2009-277534, filed on Dec. 7, 2009, the disclosure of which including the specification, drawings and abstract is incorporated herein by reference in its entirety.

### TECHNICAL FIELD

The technical field relates to a backlight apparatus and an image display apparatus using this backlight apparatus.

### BACKGROUND ART

As a type of a liquid crystal display apparatus that serves as an image display apparatus, there is a liquid crystal display apparatus that illuminates a liquid crystal panel using an LED backlight formed by arraying light emitting diodes (LEDs).

Particularly, the technique referred to as “local contrast control” is known (see Patent Literature 1 and Patent Literature 2). This technique improves contrast of a display image by arraying LEDs two-dimensionally directly below a liquid crystal panel and controlling the brightness of LEDs according to a brightness setting value (hereinafter also simply referred to as “brightness value”) of an image signal.

FIG. 1 is a block diagram showing a configuration of a liquid crystal display apparatus disclosed in Patent Literature 1. Liquid crystal display apparatus 10 shown in FIG. 1 is formed with liquid crystal display panel 11 and backlight unit 12. Backlight unit 12 is segmented into a plurality of subunits 13 (two subunits 13A and 13B are shown in FIG. 1) that can each individually adjust brightness in a surface facing liquid crystal display panel 11. The liquid crystal display section of liquid crystal display panel 11 is segmented into pixel blocks 14 (two pixel blocks 14A and 14B are shown in FIG. 1), each being a surface unit facing a corresponding subunit. Liquid crystal display apparatus 10 has first means 15 and second means 16. First means 15 calculates the maximum brightness from display data inputted in each pixel in pixel blocks 14. Second means 16 adjusts the brightness of facing subunits 13 according to the magnitude of the maximum brightness calculated in first means 15. On the other hand, in each subunit 13, the brightness value is renewed in synchronization with a vertical synchronization signal (“Vsync”).

FIG. 2 is a block diagram showing a configuration of a liquid crystal display apparatus disclosed in Patent Literature 2. In liquid crystal display apparatus 20 shown in FIG. 2, the backlight has a plurality of light emitting areas 21A to 21D that each can individually control light emission brightness using backlight brightness adjusting sections 22A to 22D. The light emission brightness in each light emitting area 21A to 21D is set according to the maximum display brightness of a corresponding display area in liquid crystal panel 23, and the transmittance of pixels of liquid crystal panel 23 is set according to the light emission brightness value of each light emitting area 21A to 21D. On the other hand, in each light emitting area 21A to 21D, the brightness value is renewed in synchronization with image signal scanning.

### CITATION LIST

### Patent Literature

PTL 1: Japanese Patent Application Laid-Open No. 2004-191490
PTL 2: Japanese Patent Application Laid-Open No. 2008-71603

### SUMMARY

### Technical Problem

Generally, in the event where a display surface of a liquid crystal panel is sectionalized into a plurality of display areas and the brightness of the backlight is controlled for each position corresponding to a display area, the following memories are required. The first one is a memory to store the feature amount of an image signal in each display area. The second one is a memory to store the brightness setting value in each light emitting area corresponding to a display area, determined based on the image signal feature amount stored. Accordingly, when the number of display areas is greater, greater memory capacity is required. Further, when the number of display areas is greater, the load to calculate backlight brightness setting values from image signal feature amounts increases (because, depending on cases, the load to determine image signal feature amounts may be included). Furthermore, when the number of display areas becomes greater, the load to transmit brightness setting values for these to a drive circuit becomes greater, and the number of transmission lines increases.

Generally, LED drive ICs are classified as follows, from the perspective of channel-specific brightness value setting. First, based on individual IC functions, LED drive ICs are classified into (1) LED drive ICs by which a brightness value for one desired channel can be set by receiving a command for one channel, and (2) LED drive ICs by which brightness values for all channels cane be set together by receiving commands for all channels. Further, in the event a plurality of identical ICs are used, LED drive ICs are further classified into (3) LED drive ICs by which ICs for which brightness values need to be set can be selected, and (4) LED drive ICs connected in a daisy chain, for which brightness values cannot be renewed unless commands for all channels of all ICs are received.

Here, problems arise when the number of display areas increases, including the above calculation load and transmission load. To reduce these loads, the brightness value of each frame may be generally renewed every G frames (where G is a natural number equal to or greater than 2). However, this causes delay in optimization of brightness in the entire screen (that is, optimization of contrast). Moreover, in a frame in which renewal is performed, the load of renewal is still high. Therefore, after a feature amount of an image signal for one screen is detected in one frame and brightness setting values for all display areas are calculated, it is necessary to transmit control signals based on these brightness setting values to a drive IC, with minimum delay. For example, with the renewal method disclosed in Patent Literature 1, the brightness value of each subunit 13 is renewed simply in synchronization with a vertical synchronization signal (“Vsync”), and therefore the above-described problems persist.

By contrast with this, for example, with the renewal method disclosed in Patent Literature 2, the brightness value of each light emitting area 21A to 21D is renewed in synchronization with image signal scanning, and therefore there is more allowance than the method disclosed in Patent Literature 1. However, in the event drive ICs having the specification of above (4) is used, the condition for transmission is more severe than the method disclosed in Patent Literature 1. This is because, in the event the display screen of liquid crystal panel 23 is sectionalized into H (where H is a natural number) in the vertical direction and renewal is performed H times in one frame in synchronization with image signal scanning, data for all light emitting areas needs to be transmitted H times in one frame. Further, in the event drive ICs having the specification of above (2) or (3) is used, if wiring is designed such that channels for the drive ICs are allocated in a vertical direction, the condition for transmission becomes more severe than the method disclosed in Patent Literature 1 as described above. In order to handle these problems, although it is possible to reduce the transmission frequency by, for example, transmit data in parallel from a transmitter, there is a problem that the number of wirings and the circuit scale increase. Further, even if the transmission frequency is simply increased, there is a possibility that transmission errors occur due to problems such as clock skew, and, in addition, EMI (Electromagnetic Interference) increases caused by radiation. There are, furthermore, problems with technical standards such as SPI (System Packet Interface), I2C (Inter-Integrated Circuit), and RSDS (Reduced Swing Differential Signaling), and various other problems including allowable receiving frequencies of ICs.

Accordingly, there is a demand for a liquid crystal apparatus (particularly, a backlight apparatus) that can perform local contrast control with little memory capacity, calculation load and transmission load (including the problems of the number of wirings and radiation) when controlling brightness in individual positions in backlight corresponding to respective display areas of a display surface.

An object therefore is to provide a backlight apparatus that can perform quality local contrast control while reducing a transmission load.

### Solution to Problem

To achieve the above object, a backlight apparatus is configured to have: a light emitting section that has a light emitting surface, in which P light emitting areas (where P is an integer equal to or greater than 2) that can each individually emit light are divided into Q groups (where Q is an integer equal to or greater than 2 and equal to or smaller than P), and radiates illumination light from the P light emitting areas to a light modulating section; a detecting section that detects a feature amount of an image signal; a determining section that determines light emitting brightness values for the P light emitting areas on a per light emitting area basis, based on the feature amount detected in the detecting section; and a driving section that renews light emitting states of the P light emitting area on a per group basis based on the light emitting brightness values, and, in this back light apparatus, the driving section is configured to change a group in which a light emitting state is renewed, among the Q groups, at a frequency of M times (where M is a real number greater than 1) per one frame period of the image signal.

Furthermore, an image display apparatus is provided with the above backlight apparatus and light modulating section.

### Advantageous Effects

According to these apparatuses, it is possible to perform quality local contrast control while reducing a transmission load.

### BRIEF DESCRIPTION OF DRAWINGS

FIG. 1 is a block diagram showing an example of a configuration of a conventional liquid crystal display apparatus;

FIG. 2 is a block diagram showing another example of a conventional liquid crystal display apparatus;

FIG. 3 is a block diagram showing a schematic configuration of an image display apparatus using a backlight apparatus according to Embodiment 1 of the present invention;

FIG. 4 is a schematic diagram showing a main part configuration of an LED backlight of FIG. 3;

FIG. 5 illustrates preferable examples of grouping of light emitting areas according to Embodiment 1 of the present invention, where FIG. 5A is a schematic diagram showing an unpreferable example and FIG. 5B is a schematic diagram showing a preferable example;

FIG. 6 shows schematic diagrams showing examples of preferable variations of grouping of light emitting areas according to Embodiment 1 of the present invention, where FIG. 6A shows formation of a checkered pattern, FIG. 6B shows formation of a vertical stripe pattern, FIG. 6C shows formation of a diagonal stripe pattern and FIG. 6D shows formation of a concentric pattern;

FIG. 7 illustrates a renewal method of brightness setting according to Embodiment 1 of the present invention with two examples, where FIG. 7A is a schematic diagram showing the first example and FIG. 7B is a schematic diagram showing the second example;

FIG. 8 illustrates a renewal method of brightness setting according to Embodiment 1 of the present invention with two more examples, where FIG. 8A is a schematic diagram showing a third example another example of a conventional renewal method and FIG. 8B is a schematic diagram showing a fourth example;

FIG. 9 is a block diagram showing a schematic configuration of an image display apparatus according to Embodiment 2 of the present invention; and

FIG. 10 illustrates a renewal method of brightness setting according to Embodiment 2 of the present invention.

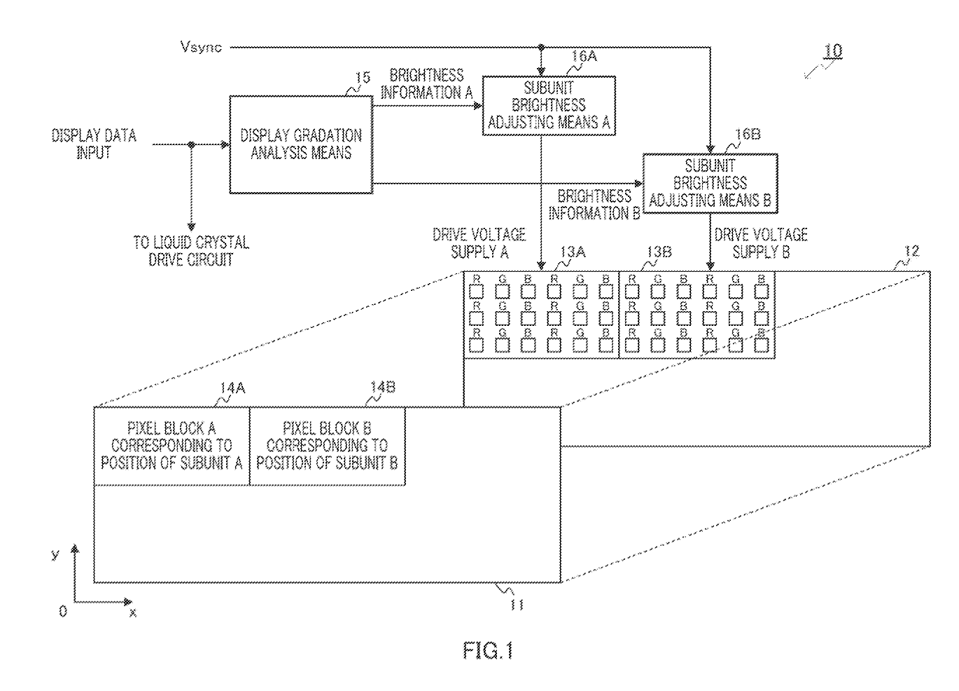

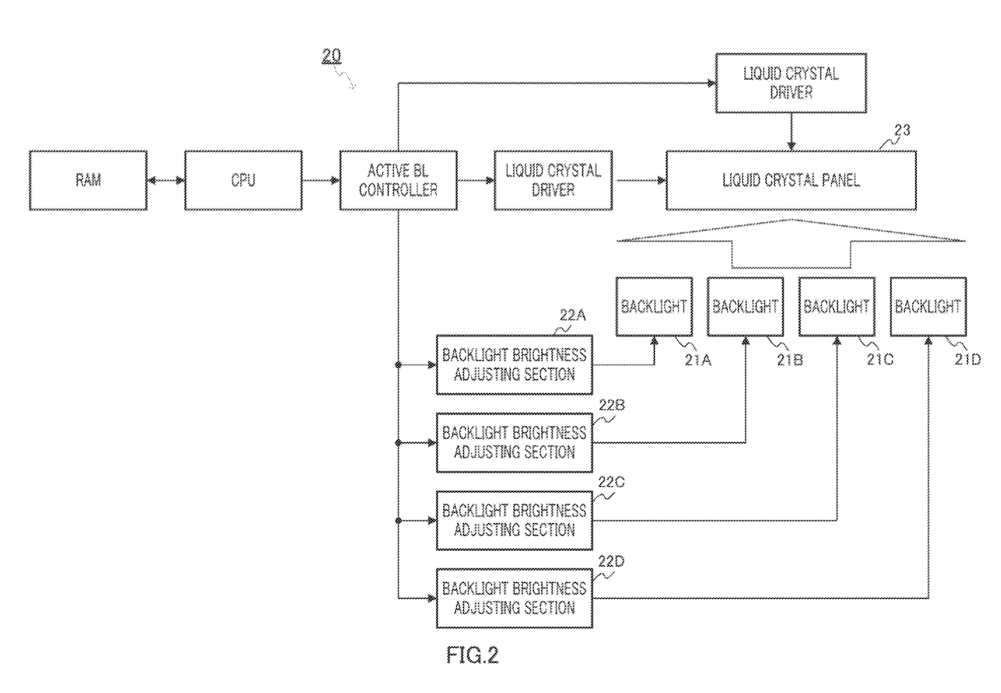

### DESCRIPTION OF EMBODIMENTS

Hereinafter, an embodiment of the present invention will be explained in detail with reference to the accompanying drawings.

### Embodiment 1

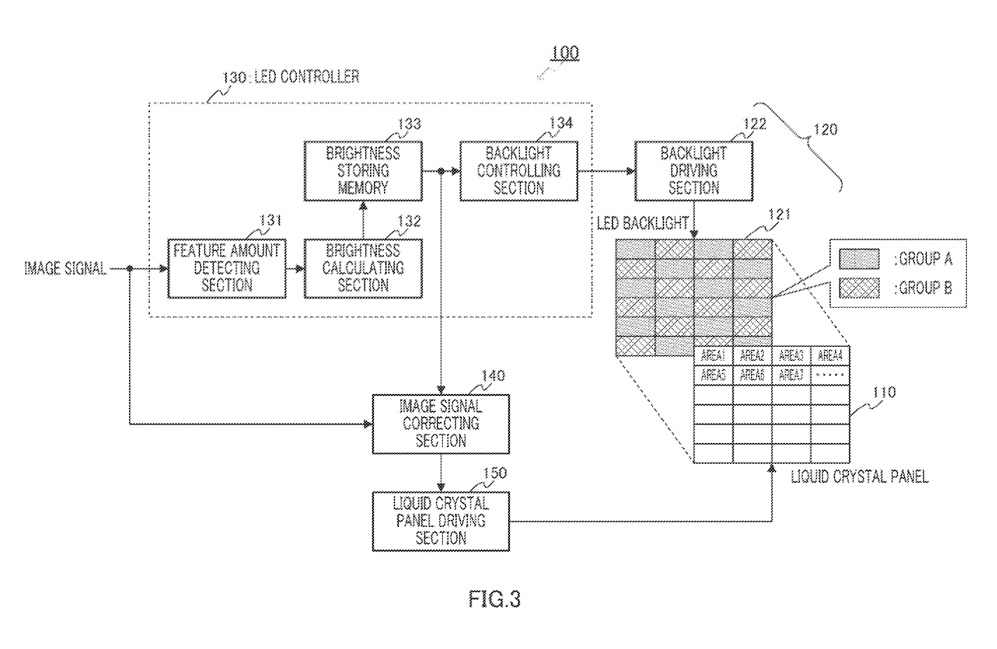

FIG. 3 is a block diagram showing a schematic configuration of an image display apparatus using a backlight apparatus according to Embodiment 1 of the present invention.

Image display apparatus 100 shown in FIG. 3 expands the dynamic range of a display image and improves contrast of the display image by controlling the brightness of a backlight light source that radiates illumination light onto the back surface of liquid crystal panel 110, according to an image signal. Further, image display apparatus 100 can save power of the apparatus. Roughly, this image display apparatus 100 has liquid crystal panel 110, illuminating section 120, LED controller 130, image signal correcting section 140, and liquid crystal panel driving section 150. Illuminating section 120 has LED backlight panel 121 (hereinafter simply “LED backlight”) and backlight driving section 122. Further, LED controller 130 has feature amount detecting section 131, brightness calculating section 132, brightness storing memory 133 and backlight controlling section 134. Note that the backlight apparatus is formed with illuminating section 120 and LED controller 130.

Liquid crystal panel 110, which serves as a light modulating section, has a function of optically modulating illumination light radiated onto the back surface of liquid crystal panel 110 according to an image signal, and creating an image on a display surface based on that image signal. Liquid crystal panel 110 is, for example, a common liquid crystal panel, and is formed with a polarizing plate, liquid crystal cell and color filter (not shown). The display surface of liquid crystal panel 110 is sectionalized into a plurality of display areas (i.e. sectional areas), as shown in FIG. 3. Note that the light modulating section is formed with liquid crystal panel 110 with the present embodiment, and therefore image display apparatus 100 will be referred to as “liquid crystal display apparatus 100” in the following explanation.

Illuminating section 120 radiates illumination light for displaying an image on liquid crystal panel 110 from the back of liquid crystal panel 110. Illuminating section 120 has LED backlight 121 and backlight driving section 122 as described above.

LED backlight 121, which serves as a light emitting section, is arranged to face the back surface of liquid crystal panel 110, and radiates illumination light from the back of liquid crystal panel 110. LED backlight 121 has a plurality of light emitting areas for illuminating a plurality of display areas of liquid crystal panel 110, and is configured to be able to mission brightness per light emitting area. Each light emitting area is arranged to face a corresponding display area of liquid crystal panel 110, and mainly radiates that facing display area. Here, the word “mainly” is used because each light emitting area radiates part of its illuminating light on other image display areas that the light emitting area does not face. Each light emitting area has LEDs 123 as light sources.

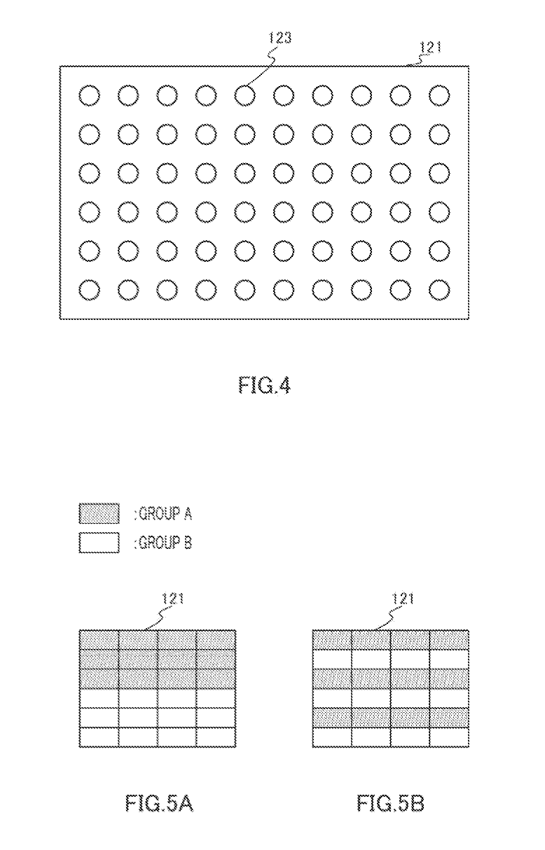

FIG. 4 is a schematic diagram showing a main part configuration of LED backlight 121, where a specific example of array of LEDs 123 in LED backlight 121 is shown. LED backlight 121 has multiple (here, 6×10=60, for ease of explanation) LEDs 123 (for example, white LEDs), as shown in FIG. 4. LED backlight 121 is a direct type backlight panel in which these multiple LEDs 123 are arrayed in virtually a planar shape on a substrate, being oriented toward the back surface of liquid crystal panel 110.

Backlight driving section 122, which serves as a driving section, drives LED backlight 121. To be more specific, backlight driving section 122 can drive LEDs 123 of LED backlight 121, either all individually or in units of a plurality of LEDs 123, thereby making it possible to adjust the brightness of each light emitting area of LED backlight 121. For example, backlight driving section 122 uses one or a plurality of LED drive ICs such that the total number of channels is equal to or greater than the number of light emitting areas of LED backlight 121. Then, backlight driving section 122 employs a configuration (not shown) in which individual channels of LED ICs correspond to individual light emitting areas of LED backlight 121 on a one-by-one basis. With this configuration, the brightness of LED backlight 121 can be controlled for each individual light emitting area. That is, there are LED drive ICs in which the number of outputs is one channel (i.e. one-channel output type) and LED drive ICs in which the number of outputs is multiple channels (i.e. multi-channel output type). In either type, each individual channel is connected to LEDs 123 that belong to a corresponding light emitting area of LED backlight 121. By this means, backlight driving section 122 controls brightness of light sources (i.e. LEDs 123) per light emitting area of LED backlight 121. In this case, all LEDs 123 belonging to one light emitting area emit light at the same brightness according to signals from corresponding channels of LED drive ICs.

Note that, if an IC is required for every light emitting area, one-channel output type LED drive ICs are used, whereas, if the number of ICs required is smaller than the number of light emitting areas, multi-channel output type LED drive ICs are used. Practically speaking, the number of light emitting areas of LED backlight 121 (that is, the number of sections of the display surface of liquid crystal panel 110) ranges from 64 to 1000 and is large, and therefore using one-channel output type LED driver ICs alone is difficult. Hence, a configuration to use one or a plurality of multi-channel output type LED drive ICs is generally employed. In this case, the total number of channels of one or a plurality of LED drive IC channels is equal to or greater than the number of light emitting areas so that each light emitting area can be driven individually.

With the above configuration, illuminating section 120 can control brightness on a per light emitting area basis. In illuminating section 120, LED backlight 121 is arranged on the back surface side of liquid crystal panel 110 to illuminate liquid crystal panel 110 by a white light (i.e. illumination light) emitted from LEDs 123, the brightness of which is controlled per light emitting area.

Note that the light sources of LED backlight 121 are not limited to LEDs 123, as long as these light sources are arranged so that brightness can be adjusted on a per light emitting area basis. For example, the light sources of LED backlight 121 may emit a white light by blending red, green and blue lights.

LED controller 130 has the function of calculating a light emission brightness value (i.e. brightness setting value) per light emitting area of LED backlight 121 from an input image signal, and outputting the light emission brightness value to backlight driving section 122. LED controller 130 has feature amount detecting section 131, brightness calculating section 132, brightness storing memory 133 and backlight controlling section 134 as described above.

Feature amount detecting section 131, which serves a detecting section, detects the feature amount of an input image signal. To be more specific, feature amount detecting section 131 detects the feature amount of an input image signal per display area of liquid crystal panel 110. Here, “feature amount” refers to the amount of feature related to the brightness of an image signal in each display area of liquid crystal panel 110. For the feature amount, it is possible to use, for example, the maximum brightness level, minimum brightness level, the difference between the maximum brightness level and the minimum brightness level or the average brightness, of an image signal in each display area of liquid crystal panel 110. The detected feature amount is outputted to brightness calculating section 132. Note that image signals are inputted not only to feature amount detecting section 131 but also to image signal correcting section 140.

Brightness calculating section 132, which serves as a determining section, determines light emission brightness values on a per light emitting area basis, by calculating the light emission brightness values of the light emitting areas of LED backlight 121 corresponding to respective display areas, based on image signal feature amounts detected per display area of liquid crystal panel 110. To be more specific, for example, brightness calculating section 132 calculates light emission brightness values (that is, brightness setting values) indicating the brightness at which each light emitting area corresponding to a display area must emit light, from feature amounts detected on a per display area basis, using a conversion table or conversion functions having predetermined characteristics. The calculated light emission brightness values are outputted to brightness storing memory 133.

Brightness storing memory 133 temporarily stores the calculation result of brightness calculating section 132 (i.e. light emission brightness values of the light emitting area of LED backlight 121 corresponding to respective display areas of liquid crystal panel 110). Brightness storing memory 133 is formed with, for example, a register. The light emission brightness values stored in brightness storing memory 133 are outputted to backlight controlling section 134 and image signal correcting section 140.

Backlight controlling section 134 reads from brightness storing memory 133 the light emission brightness values of the light emitting areas corresponding to respective display areas, and generates a control signal for backlight driving section 122. The generated control signal is outputted to backlight driving section 122.

Note that backlight driving section 122 drives LED backlight 121 as described above, based on the control signal from backlight controlling section 134. As described above, this control signal is generated based on light emission brightness values calculated in brightness calculating section 132. Thus, when LED backlight 121 is driven based on this control signal, each light emitting area emits light according to a light emission brightness value suitable for the feature amount of an image signal. That is, the light emitting state of each light emitting area of LED backlight 121 is renewed by driving LED backlight 121 (i.e. renewal of brightness setting) using a control signal that is based on light emission brightness values, which are brightness setting values.

Image signal correcting section 140 corrects an image signal inputted to liquid crystal panel 110, based on a light emission brightness value calculated in LED controller 130. To be more specific, image signal correcting section 140 reads the light emission brightness values for each light emitting area of LED backlight 121, from brightness storing memory 133, and corrects an image signal inputted to liquid crystal panel 110 based on the read light emission brightness values. In this way, an image signal inputted to liquid crystal panel 110 is optimized according to the light emission brightness values of the light emitting areas of LED backlight 121 corresponding to respective display areas. The corrected image signal is outputted to liquid crystal panel driving section 150. Note that information used for correction may be, for example, a signal (that is, the feature amount) from feature amount detecting section 131, instead of data from brightness storing memory 133 (that is, light emission brightness values).

Liquid crystal panel driving section 150 drives liquid crystal panel 110 based on the image signal corrected by image signal correcting section 140.

Note that image signals may be inputted to liquid crystal panel driving section 150 without correction. However, as described above, by optimizing an image signal inputted to liquid crystal panel 110 taking into account the light emission brightness of LED backlight 121 that illuminates the back surface of liquid crystal panel 110, it is possible to display an image in better contrast and gradation. By contrast with this, it is equally possible to determine brightness setting values for LED backlight 121 taking this correction into account.

Next, the LED controlling method for LED backlight 121 in liquid crystal display apparatus 100 employing the above configuration will be explained.

In the event multiple LEDs 123 are arranged as light sources for LED backlight 121, the number of LEDs 123 is preferably set to a number that can be divided by the number of light emitting areas P (where P is an integer equal to or greater than 2). In this case, given P light emitting areas, the same number of LEDs 123 are included in all of the light emitting areas corresponding to respective display areas, and LEDs 123 inside each light emitting area are driven at the same brightness per light emitting area.

An LED drive IC used to drive LEDs generally has a multi-channel current source, and can drive connecting loads (here, LEDs 123) using varying current values. The LEDs are connected and driven such that LEDs of one light emitting area are connected with one channel. However, the scheme of using the same current value for all ICs and changing brightness values on a per channel basis by performing PWM (Pulse Width Modulation) drive per channel, is more popular. This brightness value setting is generally performed by receiving digital data from a controlling section (here, LED controller 130) according to transmission schemes such as the above-mentioned SPI, I2C or RDSD.

As described above, LED drive ICs are generally classified as follows based on the brightness value setting of each channel. First, based on individual IC functions, LED drive ICs are classified into (1) LED drive ICs by which a brightness value for one desired channel can be set by receiving a command for one channel, and (2) LED drive ICs by which brightness values for all channels cane be set together by receiving commands for all channels. Further, in the event a plurality of identical ICs are used, LED drive ICs are further classified into (3) LED drive ICs by which ICs for which brightness values need to be set can be selected, and (4) LED drive ICs connected in a daisy chain, for which brightness values cannot be renewed unless commands for all channels of all ICs are received.

Here, problems arise when the number or display areas increases, including the above-mentioned problems of calculation load and transmission load. With the example of FIG. 3, the calculation load refers to the calculation load in brightness calculating section 132 (which might include the calculation load in feature amount detecting section 131, depending on cases), and the transmission load refers to the load to transmit digital data from backlight controlling section 134 to backlight driving section 122. The techniques disclosed in Patent Literature 1 and Patent Literature 2 are not essentially directed to reducing these loads. However, even if the renewal method disclosed in Patent Literature 1 and the renewal method disclosed in Patent Literature 2 are used to reduce these loads, there is a certain limitation in these renewal methods as described above.

Hence, with the present invention, a plurality of light emitting areas (i.e. P light emitting areas, where P is an integer equal to or greater than 2) are vided into a plurality of groups (i.e. Q groups, where Q is an integer equal to or greater than 2 and equal to or smaller than P) to reduce memory capacity, calculation load and transmission load. Then, the present invention is configured to switch the groups subject to renewal of light emission brightness setting (hereinafter also simply referred to as “brightness setting”) more frequently than once during one image signal frame period, that is, change the groups subject to renewal of the light emitting state. Note that, as described above, the number of the display areas of liquid crystal panel 110 and the number of the light emitting areas of LED backlight 121 are the same, these display areas and light areas correspond to each other on a one-by-one basis, and therefore the grouping of light emitting areas is equivalent to the grouping of display areas.

Hereinafter, an explanation will be given mainly using light emitting areas as target of grouping.

To be more specific, with the present embodiment, P light emitting areas are grouped into Q groups each formed with virtually an equal number of light emitting areas. Preferably, the same number of light emitting areas belong to all of the Q groups. Then, light emission brightness values are calculated on a per light emitting area basis, at a frequency of L times per one frame period (where L is an integer equal to or greater than 1). Further, brightness setting is renewed on a per groups basis, at a frequency of N times per one frame period (where N is a real number equal to or greater than L, and greater than 1). Furthermore, the groups subject to brightness setting renewal are changed at a frequency of M times per one frame period (where M is a real number between L and N, and greater than 1).

Hereinafter, the arrangement of groups will be explained first. Note that, for ease of explanation, a case will be explained as an example where 6×4=24 light emitting areas are divided into two groups, having the same number of belonging light emitting areas (group A and group B), and where changing of groups and renewal of brightness setting are performed four times in one frame at the same cycle.

FIG. 5 illustrates preferable examples of grouping of light emitting areas according to Embodiment 1 of the present invention, where FIG. 5A is a schematic diagram showing an unpreferable example and FIG. 5B is a schematic diagram showing a preferable example.

First, as shown in FIG. 5A, on a light emitting surface formed with all light emitting areas, such grouping is not preferable where light emitting areas of each group are concentrated per group (that is, light emitting areas in each group gather in one place) and are disproportionate (that is, light emitting areas concentrate in specific locations and lack overall balance). As shown in FIG. 58, grouping is preferable where light emitting areas of each group are distributed almost evenly (i.e. uniformly) over the entire light emitting surface. To be more specific, when, for example, an origin is placed in the center of the display surface of liquid crystal panel 110, grouping is performed by selecting light emitting areas such that the median points of the groups concentrate near this origin. Thus, in the event where, for example, ICs of above (1) or ICs combining above (2) and (3) are used, the number of light emitting areas for which brightness setting renewal can be performed at one time is 1/Q of the total number of light emitting areas, and therefore the transmission load upon one renewal also becomes 1/Q. Also, in the event ICs of above (4) are used, the same advantages can be provided by using the ICs skillfully by, for example, applying a number of ways of daisy chain connection corresponding to the number of groups, to the ICs. Further, the groups are distributed virtually uniformly over the entire light emitting surface, so that it is possible to renew brightness smoothly with less visual unnaturalness.

On the other hand, in the event switching needs to be performed with allowance, the groups subject to renewal of brightness setting (hereinafter also referred to simply as “brightness renewal groups”) may be switched when brightness setting is renewed several times. In other words, the cycle of changing the groups subject to renewal of brightness may be set to an integral multiple (double or greater here) of the cycle of brightness setting renewal. For example, the brightness renewal group may be switched when brightness setting is renewed twice. In this case, if given the premise that the light emitting areas to form the light emitting surface are divided into two groups, in one frame, brightness setting renewal is performed four times and group changing is performed twice.

Light emission brightness values to use upon renewal of brightness setting provide greater effectiveness if calculated only with respect to the groups that reflect these values. In other words, it is preferable to calculate light emission brightness values per light emitting area and renew the light emitting state per group at the same cycle, and, upon renewing the brightness setting for light emitting areas belonging to a certain group, calculate the light emission brightness values only for the light emitting areas belonging to that group. By this means, it is possible to reduce the calculation load and reduce the memory capacity required.

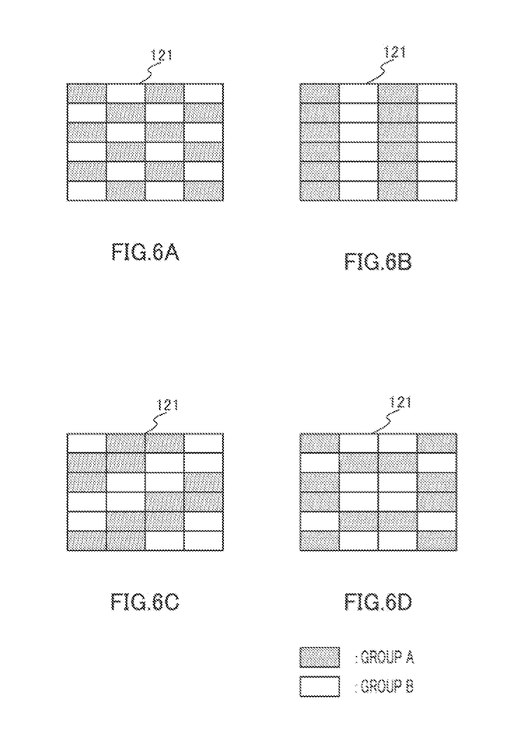

FIG. 6 shows schematic diagrams showing examples of preferable variations of grouping of light emitting areas according to Embodiment 1 of the present invention, where FIG. 6A shows formation of a checkered pattern, FIG. 6B shows formation of a vertical stripe pattern, FIG. 6C shows formation of a diagonal stripe pattern and FIG. 6D shows formation of a concentric pattern.

That is to say, in the example shown as FIG. 6A, light emitting areas belonging to two groups A and B are arranged in a checkered pattern (a pattern in which squares of two colors are placed alternately). In the example shown as FIG. 6B, light emitting areas belonging to two groups A and B are arranged in a vertical stripe pattern. In the example shown as FIG. 6C, light emitting areas belonging to two groups A and B are arranged in a diagonal stripe pattern. In the example shown as FIG. 6D, light emitting areas belonging to two groups A and B are arranged in a concentric pattern. Incidentally, in the example shown as FIG. 5B, light emitting areas belonging to two groups A and B are arranged in a horizontal stripe pattern. With these examples, if, in a certain frame, the groups are switched an even number of times every time brightness setting is renewed, brightness setting is renewed for the light emitting areas belonging to group A upon renewals of odd-numbered counts and for the light emitting areas belonging to group B upon renewals of even-numbered counts. What grouping method is selected may be determined taking into account, for example, LED drive IC control, the convenience of wiring on the substrate on which LEDs are provided, and so on.

In the examples of FIG. 5 and FIG. 6, grouping is performed such that each light emitting area belongs to only one of a plurality of groups. However, for further variations of grouping, such grouping is also possible where specific light emitting areas belong to a plurality of groups. That is to say, this is the kind of grouping whereby at least part of a plurality of light emitting areas belongs to two or more groups among a plurality of groups at the same time. When this kind of grouping is employed, grouping can be changed more dynamically, such that, for example, a specific light emitting area corresponding to a point where fast motion is detected by a motion vector analysis belongs to a plurality of groups at the same time. Consequently, the brightness setting of this specific light emitting area can be renewed more frequently, so that it is possible to optimize contrast. When an image of a scene changes and the fast motion in that point slows down again, grouping is changed again so that the specific corresponding light emitting area belonging to a plurality of groups are released.

Next, the method of renewing groups (timings) will be explained.

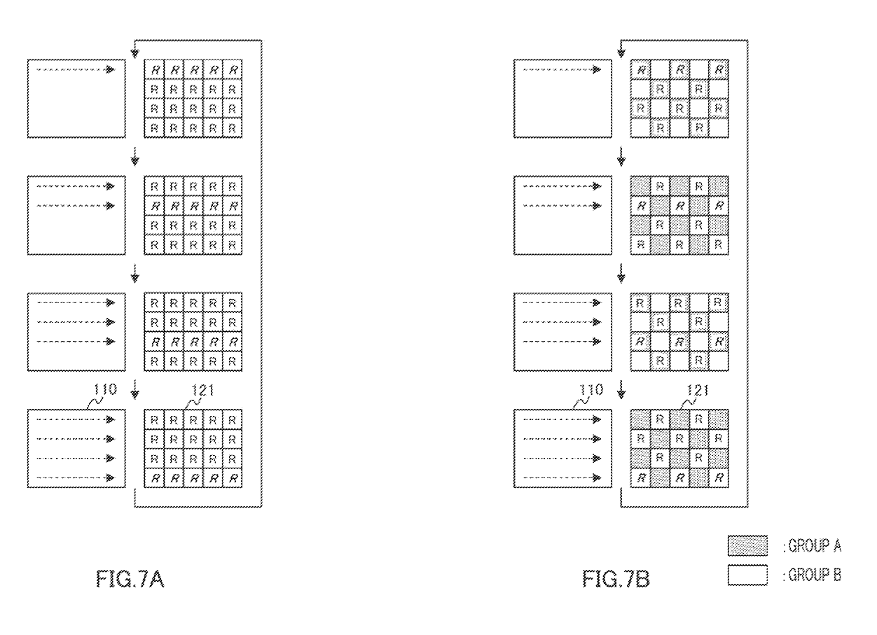

FIG. 7 illustrates a renewal method of brightness setting according to Embodiment 1 of the present invention with two examples, where FIG. 7A is a schematic diagram showing the first example and FIG. 7B is a schematic diagram showing the second example.

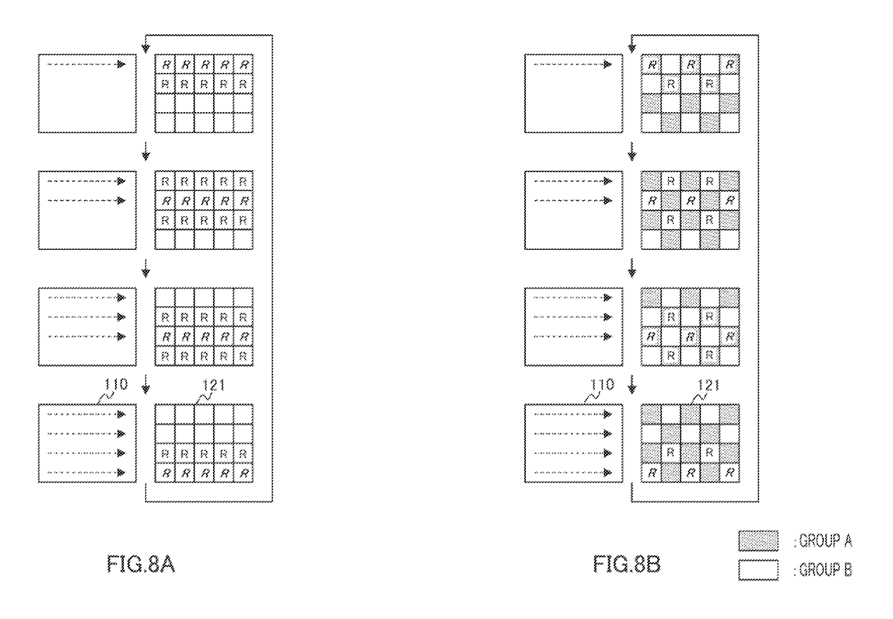

In FIG. 7A and FIG. 7B, the left half in each drawing shows how an image signal is scanned in liquid crystal panel 110 and the right half in each drawing shows how brightness setting is renewed in LED backlight 121. Furthermore, the light emitting areas where the letter “R” is written are the areas subject to renewal at individual times (“R” is an abbreviation for “renewal”). “R” written in a bold italic letter in the drawings indicates renewal for light emitting areas corresponding to a display area where the latest image signal has been written, in that frame period. The same applies to FIG. 8 (described later).

Furthermore, generally speaking, the number of display areas in the vertical direction is set smaller than the number of vertical pixels (i.e. the number of lines), but FIG. 7A and FIG. 7B are schematic diagrams and look as if these numbers were the same. The same applies to FIG. 8 (described later).

To be more specific, FIG. 7A shows the first example of a method of renewing brightness setting in synchronization with image signal scanning. This method is effective when calculating brightness information for a target display area based on image signal feature amounts in the target display area and their surrounding display areas. With this renewal method, brightness setting is renewed for light emitting areas of all display areas together, in synchronization with image signal scanning, every time pixels for one display area in the vertical direction are scanned. The brightness of light emitting areas corresponding to each display area is determined based also on feature amounts in other display areas. Consequently, every time a given display area has been scanned and the feature amount in that display area is renewed, the light emission brightness values for light emitting areas of all display areas are recalculated. By this means, the brightness setting values are always kept optimal in all light emitting areas. Furthermore, with this method, the light emitting state is also always kept optimal in all light emitting areas, and it naturally follows that the light emitting state is always kept optimal in the entire light emitting surface. However, this method requires a substantial memory capacity, which then results in a substantial calculation load and transmission load.

By contrast with this, FIG. 7B shows a second example of the renewal method according to the present embodiment. This method is similar to the example shown as FIG. 7A in that the method is effective when calculating brightness information for a target display area based on the image signal feature amounts in the target display area and their surrounding display areas. However, with this method, brightness setting is renewed collectively for the light emitting areas belonging to group A upon brightness setting of odd-numbered counts in a given frame and brightness setting is renewed collectively for the light emitting areas belonging to group B upon brightness setting of even-numbered counts in that frame. According to this method, therefore, the light emitting state is not always kept optimal in all light emitting areas. When the distribution of light emitting areas belonging to respective groups draws a checkered (that is, uniform) pattern over the entire light emitting surface, practically, the light emitting state of the entire light emitting surface is always kept optimal. Furthermore, with this method, the transmission load for brightness setting renewal can be reduced to half compared to the example shown as FIG. 7A.

FIG. 8 illustrates a renewal method of brightness setting according to Embodiment 1 of the present invention with two more examples, where FIG. 8A is a schematic diagram showing a third example of a renewal method and FIG. 8B is a schematic diagram showing a fourth example of a renewal method.

To be more specific, FIG. 8A shows a third example of a method of renewing brightness setting in synchronization with image signal scanning. This method is also effective when calculating brightness information for a target display area based on image signal feature amounts in the target display area and their surrounding display areas. With this method, the range of surrounding display areas to use as reference, is set narrow. To be more specific, the range of surrounding display areas to use as reference is set to a range the influence of which reaches a target display area (for example, a rang including one surrounding display area located above and below the target display area). With this method of renewal, brightness setting is renewed collectively for light emitting areas of all display areas, in synchronization with image signal scanning, every time pixels for one display area in the vertical direction are scanned. The brightness of light emitting areas corresponding to each display area is determined based also on the feature amounts in other display areas. Consequently, every time a given display area has been scanned and the feature amount in that display area is renewed, the light emission brightness values for the light emitting areas in a certain range influenced by the renewed feature amount, are recalculated. By this means, brightness setting values are always kept optimal in all light emitting areas. Furthermore, with this method, the light emitting state is also always kept optimal in all light emitting areas, and it naturally follows that the light emitting state is always kept optimal over the entire light emitting surface. Furthermore, since the range of one brightness calculation can be limited, so that it is possible to reduce the memory capacity required for calculation and reduce the calculation load. This method also in a way renews the brightness setting of each group, so that it is possible to limit the range of one renewal. The transmission load for brightness setting renewal can be reduced somewhat (at least 25% compared to the example shown as FIG. 7A).

By contrast with this, FIG. 8B shows a fourth example of the renewal method according to the present embodiment.

This method is also similar to the example shown as FIG. 8A in that the method is effective when calculating brightness information for a target display area based on image signal feature amounts in the target display area and their surrounding display areas. This method is similar to the example shown as FIG. 8A also in that the range of surrounding areas to use as reference is set narrow. However, with this method, brightness setting is renewed collectively for the light emitting areas belonging to group A upon brightness setting of odd-numbered counts in a given frame and brightness setting is renewed collectively for the light emitting areas belonging to group B upon brightness setting of even-numbered counts in that frame. With this method, consequently, the light emitting state cannot be always kept optimal in all light emitting areas. When the distribution of light emitting areas belonging to respective groups draws a checkered (that is, uniform) pattern over the entire light emitting surface, practically, the light emitting state of the entire light emitting surface is always kept optimal. Furthermore, with this method, the transmission load for brightness setting renewal can be reduced to half compared to the example shown as FIG. 8A.

The methods shown in FIG. 7 and FIG. 8 allow the following flexibility in the process until the transmission of brightness setting values. Feature amount detecting section 131 may detect only the feature amounts of the display areas corresponding to the light emitting areas subject to renewal or detect the feature amounts of all display areas together. Brightness calculating section 132 may calculate brightness values for only the light emitting areas of the groups subject to renewal together or calculate the brightness values of all light emitting areas together. Furthermore, with image signal correcting section 140, whether or not to correct an image signal can be chosen. In either case, if the latter is chosen, more optimized images can be acquired, whereas, if the former is chosen, the calculation load and the scale of memory capacity can be reduced. The light emission brightness value of a target display area may be calculated by taking into account only the feature amount in the target display area, that is, without taking into account the feature amounts in surrounding display areas at all. By this means, it is possible to reduce the calculation load. However, in the event feature amounts in surrounding display areas are taken into account, it is possible to take into account the feature amounts of the surrounding display areas belonging to the same group as the target display area among the surrounding display areas and feature amounts of surrounding areas not belonging to the same group, or take into account the feature amounts of only the surrounding areas belonging to the same group. In the event of the latter, it is possible to reduce the calculation load.

Furthermore, the present technique can be used together with the control called “black insertion.”

This is the technique of realizing virtual impulse drive in a liquid crystal display apparatus, which serves as a hold-type display apparatus, by temporarily turning off the backlight, sequentially, for every one image signal frame. In this case, in a period to turn off the backlight, backlight turn-off control is applied only to groups subject to brightness setting renewal (or groups not subject to brightness setting renewal).

Further, this technique can be used together with the control called “backlight scan.”

This is the technique of reducing afterimage by temporarily turning off part of the backlight sequentially in accordance with image signal scanning. This provides an, advantage of realizing virtual impulse drive in a liquid crystal display apparatus that serves a hold-type display apparatus, and furthermore provides an advantage of displaying images clearly without afterimage by not displaying images in a response delay period for an image signal on the display panel. In this case, too, control to turn off the backlight sequentially is applied only to groups subject to (or not subject to) brightness setting renewal.

By using the present technique and the above control together, it is possible to minimize the decrease in brightness when the backlight is turned off (usually, brightness is increased while light is on to increase brightness, but this increase the load on the light source and power supply).

Here, a case will be explained where sequential turn-off control is performed with respect to groups in which brightness setting is not renewed. There are LED drive ICs that can turn on or off LEDs by other methods than the method of sequentially turning off and then later turning on again. For example, LED drive ICs control LEDs to turn on and off according to brightness setting commands or according to current source ON/OFF commands for each individual channel or all channels transmitted by the same transmission scheme and transmission line as those for brightness setting commands. An LED drive IC can of this kind can be implemented by controlling a given dedicated pin simply to a high level or a low level. In this case, the transmission line for current source ON/OFF commands is not the same as the transmission lien for brightness setting commands, so that sequential turn-off control can be applied at ease to different groups from the groups subject to brightness setting renewal. Brightness setting is renewed from the purpose of improving contrast and sequential turn-off control is performed for the purpose of improving blurs in moving images. By distributing these improvement effects in a plurality of groups, it is possible to display an image such that both contrast and blurs in moving images are improved not only in specific groups alone but also in all groups, while reducing the load of control and transmission.

The present embodiment provides:

an LED backlight that has a light emitting surface in which a plurality of light emitting areas (P light emitting areas, where P is an integer equal to or greater than 2) that each individually can emit light are divided into a plurality of groups (Q groups, where Q is an integer equal to or greater than 2 and equal to or smaller than P), and that serves as a light emitting section that emits an illumination light from the light emitting areas onto a liquid crystal panel that serves as a light modulating section;
a feature amount detecting section that serves as a detecting section that detects a feature amount of an image signal;
a brightness calculating section that serves as a determining section that determines the light emission brightness values for the P light emitting areas based on feature amounts detected in the feature amount detecting section; and
a backlight driving section that serves as a driving section that renews the light emitting state in the P light emitting areas on a per group basis based on the light emission brightness values, and
the backlight driving section is designed to switch the groups for which the light emitting state such as the setting of light emission brightness is renewed, among the Q groups, at a frequency of M times per one image signal frame period (where M is a real number greater than 1). By this means, it is possible to reduce the transmission load and perform local control with high quality.

Further, when the above backlight scan technique is combined with the present invention, high-quality image display is possible by combining light source control and liquid crystal panel control with little memory capacity, calculation load and transmission load.

Note that in the event a configuration is provided in which the light source of LED backlight 121 acquires a white light by blending LEDs of three colors, R (red), G (green) and B (Blue), the method of the present invention may be applied to renewal of the blending ratio. It is known that there are three patterns of local contrast control, including control of the brightness direction, control of the chromaticity direction, and mixed control combining these. With the mixed control, in particular, the feature amount is detected for each R, G and B signal level (that is, for each color's brightness level), not per brightness of an image signal, and the brightness of LEDs of each is calculated, and the brightness of LEDs of each color is stored. As to correction of images, R components, G components and B components are corrected separately. The flow is completely the same as the outline of control of brightness alone (where an image signal is an RGB signal or color difference signal). As to transmission, even for LEDs belonging to the same light emitting area, different data is transmitted per color. Accordingly, in the event of mixed control, it is obvious that, the overall calculation load and transmission load are heavy compared to the case of controlling brightness alone. However, by using the method of the present invention, it is possible to reduce these loads without significantly undermining the quality of display images.

### Embodiment 2

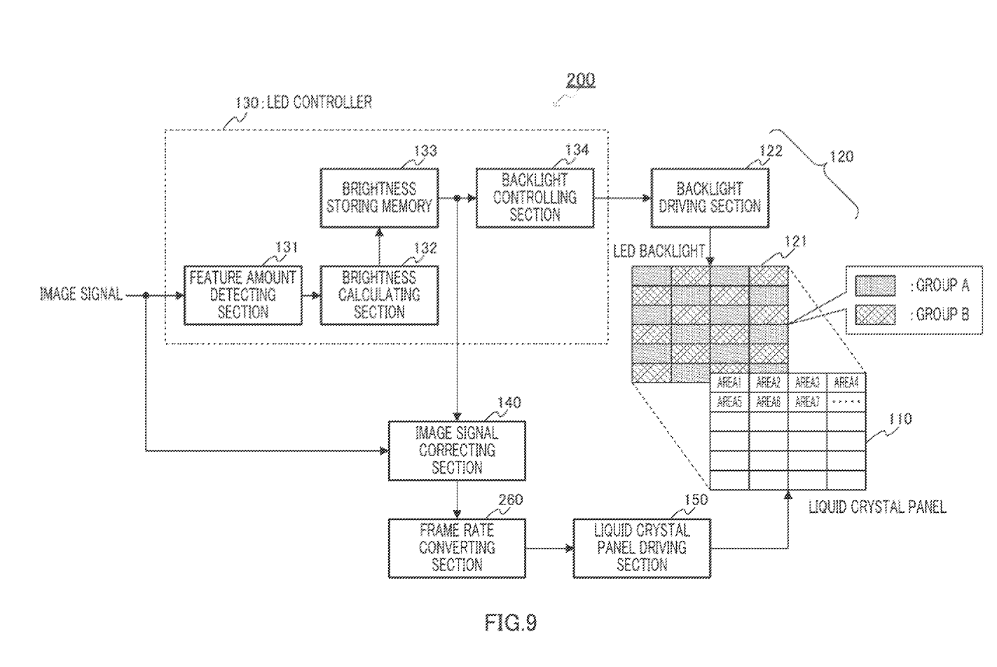

FIG. 9 is a block diagram showing a schematic configuration of an image display apparatus according to Embodiment 2 of the present invention. The image display apparatus according to the present embodiment has the same basic configuration as the image display apparatus of the above-described embodiment. Components that are identical or equivalent to the components of the previous embodiment described above will be assigned the same reference codes and will not be described in detail again, and so an explanation will be given primarily focusing on differences from the previous embodiment.

Image display apparatus 200 shown in FIG. 9 has frame rate converting section 260. The present embodiment is similar to the previous embodiment in that the light modulating section is configured with liquid crystal panel 110, so that, in the following description, image display apparatus 200 will be referred to as “liquid crystal display apparatus 200.”

Frame rate converting section 260 that serves as a frame rate converting section 260 applies conversion processing to an image signal. To be more specific, frame rate converting section 260 generates an intermediate frame from an image signal prior to being inputted to liquid crystal panel 110, to convert the vertical scanning frequency of an image signal X times greater (where X is a real number greater than 1). Assuming an original image signal of a vertical scanning frequency of 60 Hz, if, for example, the conversion rate is double, the vertical scanning frequency of the image signal after conversion processing is 120 Hz. There are cases where the conversion rate is greater than double such as triple or quadruple, or there are cases where the conversion rate is less than double such as 1.5 times. This conversion processing realizes a technique known as “double speed drive,” providing an advantage of making images smooth and reducing blurs in moving images.

Incidentally, the vertical scanning frequency may be converted before LED controller 130. However, in this case, the load per unit time increases significantly (that is, becomes X-times greater) with respect to the calculation of light illuminating brightness values and brightness setting renewal that are performed in the backlight apparatus. If this conversion processing is performed immediately before input to liquid crystal display panel 110 as is the case with the present embodiment, load in the backlight apparatus does not increase significantly, which is effective.

With liquid crystal display apparatus 200 having the above configuration, the vertical scanning frequency is different between an image signal subject to feature amount detection and an image signal inputted in liquid crystal panel 110 (that is, image that is actually displayed on liquid crystal panel 110). Consequently, with the present embodiment, brightness setting values are calculated per light emitting area, at a frequency of L times per one frame period prior to conversion, and brightness setting is renewed and the brightness renewal group is changed per group, at a frequency of L×X times per one frame period prior to conversion.

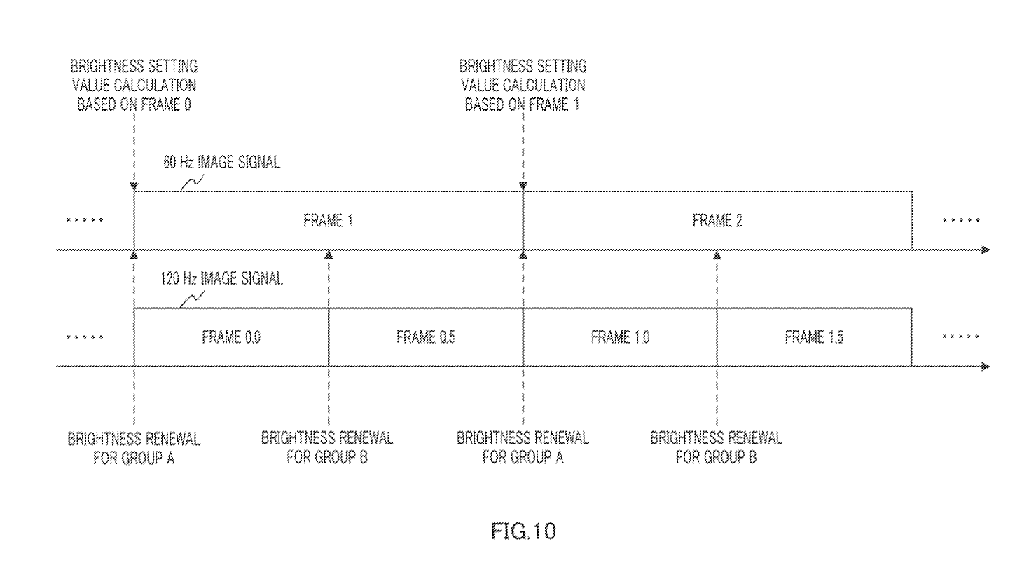

FIG. 10 illustrates a renewal method of brightness setting according to the present embodiment. A case will be described here where the vertical scanning frequency of an original image signal is 60 Hz, the conversion rate is double, and the light emitting areas to form the light emitting surface is divided into two groups (groups A and B), as shown in FIG. 9. A case will be described here as an example where brightness setting values are calculated at a frequency of once per one frame period.

When frame 0 (not shown) of an image signal prior to conversion processing (i.e. 60 Hz image signal) has been inputted in feature amount detecting section 131, feature amount detecting section 131 detects the feature amount of frame 0 in all display areas together. In accordance with this, brightness calculating section 132 calculates the brightness setting values of all light emitting areas together, based on the detected feature amounts. The calculated brightness setting values are memorized in brightness storing memory 133.

In this case, backlight controlling, section 134 reads the brightness setting values for only the light emitting areas belonging to group A from memory 133, generates a control signal based on the brightness setting values having been read, and outputs the generate control signal to backlight driving section 122.

Further, in this case, backlight driving section 122 renews the brightness of group A according to a control signal received as input from backlight controlling section 134. By this means, the light emitting state of group A reflects the brightness setting value for group A calculated based on frame 0.

Furthermore, then, frame 0.0 of an image signal (i.e. 120 Hz image signal) after conversion processing, generated in frame rate converting section 260 based on frame 0 of a 60 Hz image signal, starts being inputted in liquid crystal panel 110. Frame 0.0 stays frame 0 as is if frame 0 is not corrected, or, even if frame 0 is corrected, resembles frame 0. The light emitting state of group A then is renewed based on a brightness setting value acquired from frame 0, but is suitable also for a light emitting state for acquiring an image based on frame 0.0.

Then, when frame 1 of a 60-Hz image signal starts being inputted in frame rate converting section 260, frame rate converting section 260 start generating frame 0.5, which is an intermediate frame between frame 0 and frame 1.0. Frame 0.5 of a 120 Hz image signal is inputted in liquid crystal panel 110 following frame 0.0.

Then, backlight controlling section 134 reads the brightness setting values of only the light emitting areas belonging to group B from brightness storing memory 133, generates a control signal based on the brightness setting values having been read, and outputs the generated control signal to backlight driving section 122.

Backlight driving section 122 then renews the brightness of group B based on a control signal received as input from backlight controlling section 134. By this means, the light emitting state of group B reflects the brightness setting value for group B calculated based on frame 0. Frame 0.5 is derived from frame 0 and frame 1 and therefore resembles frame 0. The light emitting state of group B then is renewed based on a brightness setting value acquired from frame 0, but is suitable also for a light emitting state for acquiring an image based on frame 0.5.

Then, when frame 1 of a 60 Hz image signal has been inputted in feature amount detecting section 131, feature amount detecting section 131 detects the feature amount of frame 1 in all display areas together. In accordance with this, brightness calculating section 132 calculates the brightness setting values of all light emitting areas together, based on the detected feature amounts. The calculated brightness setting values are memorized in brightness storing memory 133.

In this case, backlight controlling section 134 reads the brightness setting values for only the light emitting areas belonging to group A from memory 133, generates a control signal based on the brightness setting values having been read, and outputs the generate control signal to backlight driving section 122.

Further, in this case, backlight driving section 122 renews the brightness of group A according to a control signal received as input from backlight controlling section 134. By this means, the light emitting state of group A reflects the brightness setting value for group A calculated based on frame 1.

Furthermore, then, frame 1.0 of a 120 Hz image signal, generated in frame rate converting section 260 based on frame 1 of a 60 Hz image signal, starts being inputted in liquid crystal panel 110. Frame 1.0 stays frame 1 as is if frame 1 is not corrected, or, even if frame 1 is corrected, resembles frame 1. The light emitting state of group A then is renewed based on a brightness setting value acquired from frame 1, but is suitable also for a light emitting state for acquiring an image based on frame 1.0.

Then, when frame 2 of a 60 Hz image signal starts being inputted in frame rate converting section 260, frame rate converting section 260 start generating frame 1.5, which is an intermediate frame between frame 1 and frame 2. Frame 1.5 of a 120 Hz image signal is inputted in liquid crystal panel 110 following frame 1.0.

Then, backlight controlling section 134 reads the brightness setting values of only the light emitting areas belonging to group B from brightness storing memory 133, generates a control signal based on the brightness setting values having been read, and outputs the generated control signal to backlight driving section 122.

Backlight driving section 122 then renews the brightness of group B based on a control signal received as input from backlight controlling section 134. By this means, the light emitting state of group B reflects the brightness setting value for group B calculated based on frame 1. Frame 1.5 is derived from frame 1 and frame 2 and therefore resembles frame 1. The light emitting state of group B then is renewed based on a brightness setting value acquired from frame 1, but is suitable also for a light emitting state for acquiring an image based on frame 1.5.

Thus, according to the renewal method according to the present embodiment, the cycle to calculate brightness setting values is coordinated with the frame period of an image signal prior to conversion processing, and the cycle of switching the brightness renewal group is coordinated with the frame period of an image signal after conversion processing. Consequently, the light emitting state of light emitting areas belonging to respective groups is adequately renewed as described above. Consequently, practically, the light emitting state is always kept optimal over the entire light emitting surface. This method can furthermore reduce the transmission load for brightness setting renewal as by the method of the previous embodiment. The phase difference between a 60 Hz image signal and a 120 Hz image signal, that is, the delay with the 120 Hz image signal shown in FIG. 10 produced due, to the delay of frame rate conversion processing, can be solved by delaying the brightness renewal timing of each group alike.

Embodiments of the present invention have been described above. The above embodiment can be implemented in various adequate combinations. Furthermore, the above descriptions show only examples of preferred embodiments of the present invention and by no means limit the scope of the present invention. The apparatus configurations and operations described with the above embodiments are only examples, and may be changed, added or removed without departing from the spirit of the present invention.

### INDUSTRIAL APPLICABILITY

A backlight apparatus according to the present invention provides advantages of reducing the transmission load and realizing local contrast control with high quality, and is suitable for use as a backlight for an image display apparatus that requires light sources such as a liquid crystal display. Furthermore, an image display apparatus using this backlight apparatus can be used as a liquid crystal display apparatus such as a liquid crystal television or liquid crystal monitor.

### REFERENCE SIGNS LIST

100, 200 IMAGE DISPLAY APPARATUS
110 LIQUID CRYSTAL PANEL
120 ILLUMINATING SECTION
121 LED BACKLIGHT
122 BACKLIGHT DRIVING SECTION
123 LED
130 LED CONTROLLER
131 FEATURE AMOUNT DETECTING SECTION
132 BRIGHTNESS CALCULATING SECTION
133 BRIGHTNESS STORING MEMORY
134 BACKLIGHT CONTROLLING SECTION
140 IMAGE SIGNAL CORRECTING SECTION
150 LIQUID CRYSTAL PANEL DRIVING SECTION
260 FRAME RATE CONVERTING SECTION

1. A backlight apparatus comprising:
a light emitting section that has a light emitting surface, in which P light emitting areas (where P is an integer equal to or greater than 2) that can each individually emit light are divided into Q groups (where Q is an integer equal to or greater than 2 and equal to or smaller than P), and radiates illumination light from the P light emitting areas to a light modulating section;
a detecting section that detects a feature amount of an image signal;
a determining section that determines light emitting brightness values for the P light emitting areas on a per light emitting area basis, based on the feature amount detected in the detecting section; and
a driving section that renews light emitting states of the P light emitting area on a per group basis based on the light emitting brightness values, wherein the driving section is configured to change a group in which a light emitting state is renewed, among the Q groups, at a frequency of M times (where M is a real number greater than 1) per one frame period of the image signal.

2. The backlight apparatus of claim 1, wherein:
the light modulating section has a display surface including P display areas, and displays an image on the display surface by modulating the illumination light radiated from the P light emitting areas according to the image signal;
the P light emitting areas are arranged in positions corresponding respectively to the P display areas such that the P light emitting areas illuminate the P display areas respectively; and
the P light emitting areas are configured such that are arranged such that a plurality of light emitting areas belong to the Q groups respectively and are distributed uniformly over the entire light emitting surface.

3. The backlight apparatus of claim 2, wherein the P light emitting areas are divided such that a same number of light emitting areas belong to all of the Q groups.

4. The backlight apparatus of claim 2, wherein the P light emitting areas are divided such part of the P light emitting areas belong to different groups at a same time.

5. The backlight apparatus of claim 2, wherein the P light emitting areas are divided such that the plurality of light emitting areas belonging to the Q groups respectively are arranged to be distributed in a checkered pattern.

6. The backlight apparatus of claim 2, wherein the P light emitting areas are divided such that the plurality of light emitting areas belonging to the Q groups respectively are distributed in one of a vertical stripe pattern, a horizontal stripe pattern and a diagonal stripe pattern.

7. The backlight apparatus of claim 2, wherein the P light emitting areas are divided such that the plurality of light emitting areas belonging to the Q groups respectively are arranged to be distributed concentrically.

8. The backlight apparatus of claim 2, wherein the driving section collectively renews the light emitting states of all of the plurality of light emitting areas belonging to a same group.

9. The backlight apparatus of claim 2, wherein:
the driving section collectively renews the light emitting states of part of the plurality of light emitting areas belonging to a same group; and
the part of the plurality of light emitting areas include a light emitting area arranged in a position corresponding to a display area where a latest image signal is scanned.

10. The backlight apparatus of claim 1, wherein the driving section renews a light emitting state of each group at a frequency of N times (where N is a real number greater than 1) per one frame period of the image signal.

11. The backlight apparatus of claim 10, wherein the driving section switches the group in which the light emitting state is renewed, at a frequency to equal the frequency of updating the light emitting state of each group.

12. The backlight apparatus of claim 1, wherein:
the determining section determines a light emitting brightness value of each light emitting area at a frequency of L times (where L is an integer equal to or greater than 1) per one frame period of the image signal; and
the driving section renews the light emitting state of each group at a frequency to equal or exceed the frequency of determining the light emitting brightness value of each light emitting area.

13. The backlight apparatus of claim 12, wherein the driving section changes the group in which the light emitting state is renewed at a frequency to equal the frequency of updating the light emitting state of each group.

14. The backlight apparatus of claim 1, wherein the driving section provides a period to turn off the light emitting section per one frame period of the image signal, and changes a group in which the light emitting section is turned off per turn off period.

15. The backlight apparatus of claim 1, wherein the driving section changes a period in which the light emitting section is turned off per one frame period of the image signal in accordance with scanning of the image signal, and changes a group in which the light emitting section is turned off per turn off period.

16. The backlight apparatus of claim 1, wherein:
the light modulating section modulates the illumination light according to the image signal to which conversion processing for converting a vertical scanning frequency an X times greater (where X is a real number greater than 1) has been applied;
the detecting section detects the feature amount of the image signal prior to the conversion processing;
the determining section determines the light emitting brightness values on a per light emitting area basis at a frequency of L times per one frame period of the image signal prior to the conversion processing;
the driving section renews the light emitting state of each group and changes the group in which the light emitting state is renewed, at a frequency of L×X times per one frame period of the image signal prior to the conversion processing.

17. An image display apparatus comprising the backlight apparatus of claim 1 and the light modulating section.
